(19) United States
(12) Patent Application Publication
(10) Pub. No.: US 2011/0069993 A1
(43) Pub. Date: Mar. 24, 2011

(54) DEVELOPING UNIT FOR ELECTROPHOTOGRAPHY SYSTEM IMAGE FORMING APPARATUS AND PROCESS CARTRIDGE, AND ELECTROPHOTOGRAPHY SYSTEM IMAGE FORMING APPARATUS

(75) Inventors: Takashi YAMAMURO, Kawasaki-shi (JP); Shigeru INABA, Ebina-shi (JP); Shota OBA, Ebina-shi (JP); Takashi OCHI, Ebina-shi (JP)

(73) Assignee: FUJI XEROX CO., LTD., Tokyo (JP)

(21) Appl. No.: 12/705,712

(22) Filed: Feb. 15, 2010

(30) Foreign Application Priority Data
Sep. 24, 2009 (JP) 2009-218766

(51) Int. Cl. G03G 15/08

(52) U.S. Cl. 399/254

(57) ABSTRACT

A developing unit includes a developing roller and a carrying member. The carrying member includes a main helical blade and a sub helical blade. The carrying member stirs developers containing a toner by using the main helical blade and carries in an axial direction the developers being fed to the developing roller. The sub helical blade is helically screwed in an opposite direction to the main helical blade in at least a part of the axial direction. Each of the main helical blade and the sub helical blade has carrying power of the developers. The carrying power of the sub helical blade is smaller than the carrying power of the main helical blade.

### CROSS-REFERENCE TO RELATED APPLICATION

This application is based on and claims priority under 35 USC 119 from Japanese Patent Application No. 2009-218766 filed on Sep. 24, 2009.

### BACKGROUND

1. Technical Field

The present invention relates to a developing unit for an electrophotography system image forming apparatus and a process cartridge, and an electrophotography system image forming apparatus.

2. Related Art

It is an object of the present invention to provide a developing unit that contributes to increase charge amount of the toner, and a process cartridge and an electrophotography system image forming apparatus containing the same.

### SUMMARY

[1] According to an aspect of the invention, a developing unit includes a developing roller and a carrying member. The carrying member includes a main helical blade and a sub helical blade. The carrying member stirs developers containing a toner by using the main helical blade and carries in an axial direction the developers being fed to the developing roller. The sub helical blade is helically screwed in an opposite direction to the main helical blade in at least a part of the axial direction. Each of the main helical blade and the sub helical blade has carrying power of the developers. The carrying power of the sub helical blade is smaller than the carrying power of the main helical blade.

### BRIEF DESCRIPTION OF THE DRAWINGS

Exemplary embodiments of the present invention will be described in detail based on the following figures, wherein:

FIG. 1 is a schematic sectional view showing a developing unit in the present embodiment;

FIG. 2 is a schematic view showing an internal configuration of the developing unit;

FIG. 3 is a view explaining a function of a trimmer; and

FIG. 4 is a view showing a change in charge amount of the toner in time.

### DETAILED DESCRIPTION

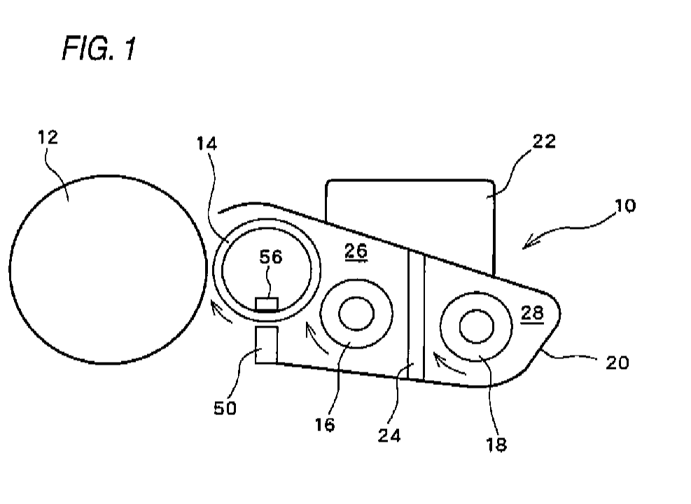

Exemplary, an embodiment of the present invention will be explained in accordance with the drawings hereinafter. FIG. 1 is a sectional view showing a schematic configuration of a developing unit 10 of an electrophotography system image forming apparatus of the present embodiment. The electrophotography system image forming apparatus has the developing unit 10 to supply the toner onto the photosensitive member on which the electrostatic latent image and development the latent image. The developing unit 10 includes a developing roller 14 opposing to a photosensitive drum 12, and two carrying members 16, 18 with blades for supplying the developers to a surface of the developing roller 14. One carrying member with blade located on the developing roller 14 is referred to as the carrying member 16 with front blade, and the other carrying member with blade is referred to as the carrying member 18 with rear blade. The developing roller 14 and the carrying member 16 with front blade and the carrying member 18 with rear blade are installed in a housing 20. A developer container 22 for containing the developers is provided integrally with the housing 20. The developer container may be constructed separately from the housing 20, i.e., independently with the developing unit 10. An interior of the housing 20 is partitioned into a front space 26 in which the carrying member 16 with front blade is contained, and a rear space 28 in which the carrying member 18 with rear blade is contained, by a partition wall 24.

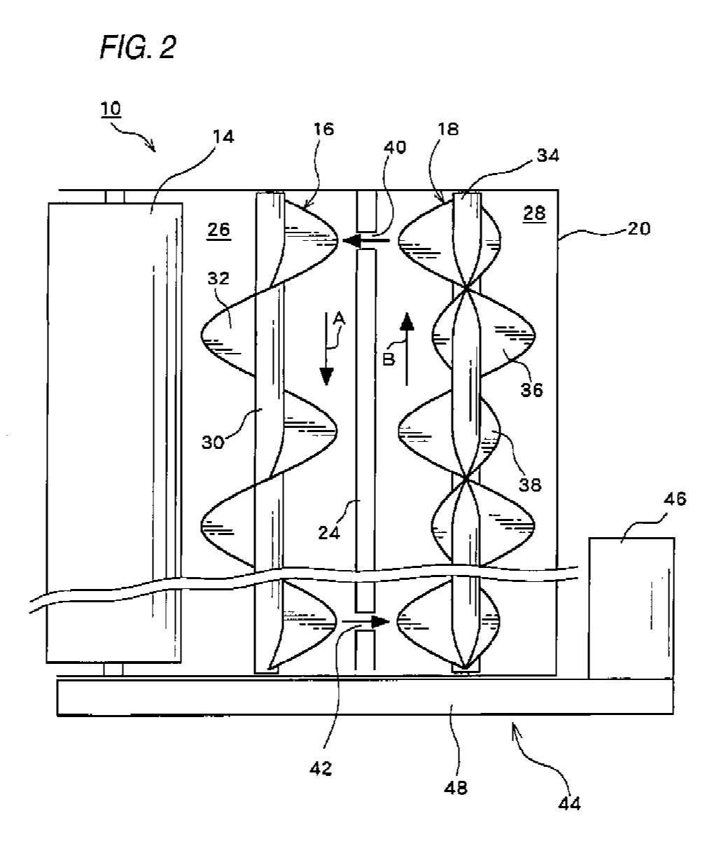

FIG. 2 is a schematic view showing a schematic configuration of the interior of the housing 20 of the developing unit when viewed from the direction that intersects orthogonally with shafts of the developing roller 14 and two carrying members 16, 18 with blade. The developing roller 14 and two carrying members 16, 18 with blade are arranged in parallel. The carrying member 16 with front blade contains a shaft 30, and a main helical blade 32 provided to wind helically around this shaft. According to the rotation of the carrying member 16 with front blade around its own shaft, the developers in the front space 26 are fed in the axial direction indicated with an arrow A while being stirred. Also, the developers are fed to the developing roller 14. The carrying member 18 with rear blade contains a shaft 34, and a main helical blade 36 and a sub helical blade 38 both provided to wind helically around this shaft. According to the rotation of the carrying member 16 with front blade around its own shaft, the developers in the rear space 28 is fed in the axial direction indicated with an arrow B by the main helical blade 36 while being stirred. The sub helical blade 38 is helically screwed in the opposite direction to the main helical blade 36, and its height is set lower. In this present embodiment, respective helical pitches of the main helical blade 36 and the sub helical blade 38 are set equal to each other. But another helical pitch may be employed. Also, a height of the blade of the sub helical blade 38 is set to 0.5 of the height of the main helical blade 36 in this present embodiment. In this case, another height may be employed if the developers can be fed in the direction indicated with an arrow B as a whole. In another case, the height of the sub helical blade may be set to range 0.01 to 0.8 of the height of the main helical blade. In further another case, the height of the sub helical blade may be set to range 0.1 to 0.7 of the height of the main helical blade. In further another case, the height of the sub helical blade may be set to range 0.2 to 0.5 of the height of the main helical blade. Accordingly, carrying power of the sub helical blade 38 is smaller than the carrying power of the main helical blade 36.

Openings 40, 42 are provided in vicinity of both ends of the partition wall 24 respectively. The developers can move between the front space 26 and the rear space 28 through the openings 40, 42. As described above, the developers contained in the front space 26 and fed by the carrying member 16 with front blade in the direction indicated with an arrow A reaches the bottom end portion in FIG. 2, and then enters into the rear space 28 through the opening 42. In the rear space 28, the developers are fed by the carrying member 18 with rear blade in the direction indicated with an arrow B, then reach the top end portion in FIG. 2, and then enter into the front space 26 through the opening 40. In this manner, the developers are circulated throughout the housing 20, and the toner in the developers is charged due to the stirring performed at that time.

The helically screwing direction of the sub helical blade 38 is opposite to the main helical blade 36. Therefore, the developers are fed by the sub helical blade 38 oppositely to the feeding direction of the main helical blade 36, i.e., oppositely to the direction indicated with an arrow B. As a result, when the carrying member 18 with rear blade is rotated, the developers located in vicinity of the shaft 34 are fed in the opposite direction to the direction indicated with an arrow B and the developers located on the outer side are fed in the direction indicated with an arrow B. On account of the feeding actions made in the opposing directions, friction is produced between respective developers and the charging is promoted.

A driving unit 44 for rotating/driving the developing roller 14 and the carrying member 16 with front blade and the carrying member 18 with rear blade is arranged on the side (at the bottom in FIG. 2) of the housing 20 of the developing unit. The driving unit 44 includes a motor 46, and a gear train 48 that transfers the rotation of the motor to the developing roller 14 and the carrying member 16 with front blade and the carrying member 18 with rear blade. The gear train 48 is illustrated schematically in FIG. 2.

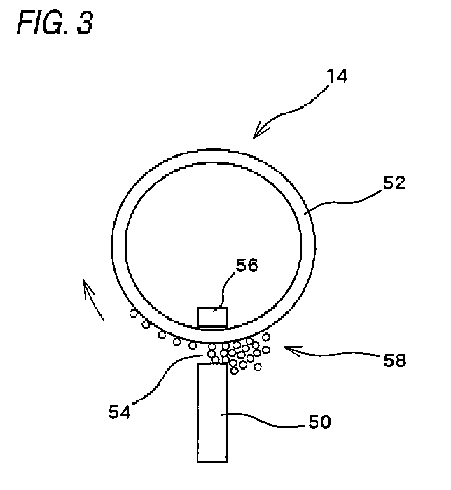

FIG. 3 is a view explaining a function of a trimmer 50 that causes a predetermined amount of the developers to attach to the developing roller 14. The developing roller 14 has a sleeve 52 that is formed of nonmagnetic material and is formed into a cylinder shape. Plural permanent magnets are provided on the inner side of the sleeve. In FIG. 3, only permanent magnets 56 arranged in positions opposing to the trimmer 50 are illustrated. The trimmers 50 are arranged at a predetermined clearance to oppose to the outer side surface of the sleeve 52. A clearance 54 between the trimmer 50 and the sleeve 52 is depicted largely in an exaggerated manner in FIG. 3. At least a part of the trimmer 50 is formed of magnetic material, and lines of magnetic force are extended between the magnetic material portions and the permanent magnets 56. Developers 58 contain the magnetic carriers and the nonmagnetic toners, and the magnetic carriers are held in the clearance 54 by the magnetic force of the permanent magnet 56. The developers 58 being held in the clearance 54 block the developer that is fed by the rotation of the sleeve 52. A part of the blocked developers 58 is fed to the position opposing to the photosensitive drum 12 according to the rotation of the sleeve 52. Here, only the toner transfers from the surface of the carrier to the photosensitive drum 12.

Also, friction is produced between the developers 58 being held in the clearance 54 and the developers that are moved along with the rotation of the sleeve 52, and thus these developers 58 are also charged. When an amount of blocked developers 58 is large, such developers are a burden on the rotation of the sleeve 52. In contrast, an amount of blocked developers 58 is small, the charging in this portion is decreased, and in some cases it is impossible to give a required charge amount to the toner. From an aspect of overcoming a shortage of charge amount, the sub helical blade 38 provided to the carrying member 18 with rear blade in the present embodiment functions effectively.

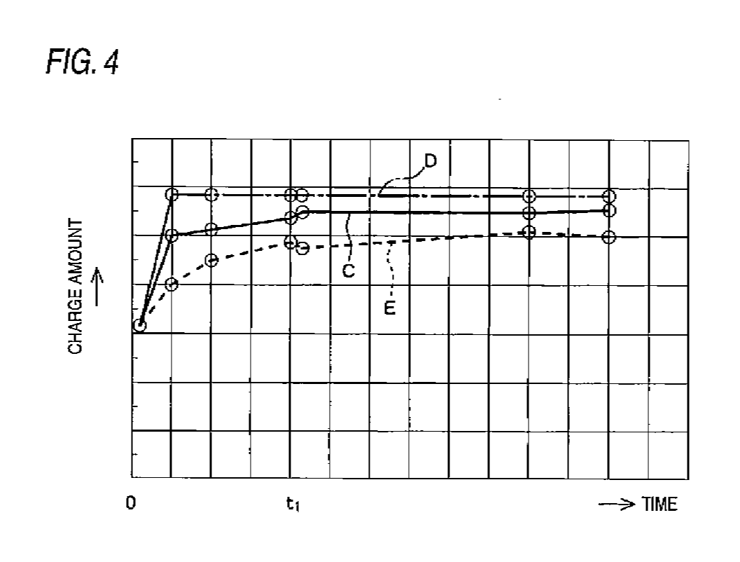

FIG. 4 is a view showing a change in charge amount of the toner in time. The carrying member with blade, an outer diameter of a shaft of which is 6 mm and an outer diameter of the main helical blade of which is 14 mm, are employed respectively, and a rotation speed is 325 rpm. An outer diameter of the developing roller is 18 mm, and a rotation speed is 325 rpm. A solid line C shows a graph of charge amount when two carrying members 16, 18 with blade in the present embodiment are rotated/driven in a state that the developing roller 14 is stopped. In contrast, a dot-dash line D shows a graph of charge amount when the developing roller 14 and two carrying members with blade and without sub helical blade are rotated/driven, and a broken line E shows a graph of charge amount when two carrying members with blade and without sub helical blade are rotated/driven. In all cases, the toner is added to the developer in the housing at time t1 by a weight ratio of 5%. A difference between the dot-dash line D and the broken line E is caused depending on whether or not the developing roller 14 is rotated. It is appreciated that, when the developing roller 14 is not rotated, charge amount of the toner is lowered. Also, a difference between the solid line C and the broken line E is caused depending on whether or not the carrying member with rear blade has the sub helical blade 38. It is appreciated that, when the sub helical blade 38 is provided, charge amount of the toner is improved. Also, it is confirmed separately that, even after the toner is added at a time t1, the additional toner is charged quickly by the carrying member 18 with rear blade, to which the sub helical blade 38 is provided. With the above, it is appreciated that the provision of the sub helical blade 38 to the carrying member 18 with rear blade can serve as one means for recovering a reduction in charge amount of the toner caused due to a reduction of amount of the developer that is blocked by the trimmer 50.

In the present embodiment, the height of the sub helical blade 38 is lower than the height of the main helical blade 36. In this case, the sub helical blade 38 may be perforated to lessen the carrying power of the sub helical blade 38. Also, the slope of the sub helical blade 38 may be changed to lessen the carrying power of the sub helical blade 38.

In the present embodiment, the sub helical blade 38 is provided only to the carrying member 18 with rear blade. In this case, the sub helical blade 38 may be provided to the carrying member 16 with front blade. Also the sub helical blade 38 may be provided to a part of the carrying member with blade in the axial direction.

In the present embodiment, the height of the sub helical blade 38 is set only to 0.5 of the height of the main helical blade 36. Also, the height of the sub helical blade 38 may be set to range 0.01 to 0.8 of the height of the main helical blade 36. The height of the sub helical blade 38 may be set to range 0.1 to 0.7 of the height of the main helical blade 36. Preferably, the height of the sub helical blade 38 may be set to range 0.2 to 0.5 of the height of the main helical blade 36. The Inventor of this application confirms that all of ranges above are effective for increasing charge amount of the toner.

The developing unit 10 in the present embodiment may be provided as a part of the so-called process cartridge that is integrated together with the photosensitive drum 12 and the developer container 22 and is detachably attached integrally to the image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understood the invention for various embodiments and with the various modifications as are suited to the particular use contemplated. It is intended that the scope of the invention be defined by the following claims and their equivalents.

What is claimed is:

1. A developing unit comprising:
a developing roller; and
a carrying member including a main helical blade and a sub helical blade, that (i) stirs developers containing a toner by using the main helical blade, and (ii) carries in an axial direction the developers being fed to the developing roller,
wherein the sub helical blade is helically screwed in an opposite direction to the main helical blade in at least a part of the axial direction,
each of the main helical blade and the sub helical blade has carrying power of the developers, and
the carrying power of the sub helical blade is smaller than the carrying power of the main helical blade.

2. A developing unit comprising:
a developing roller; and
a carrying member including a main helical blade and a sub helical blade, that (i) stirs developers containing a toner by using the main helical blade, and (ii) carries in an axial direction the developers being fed to the developing roller,
wherein the sub helical blade is helically screwed in an opposite direction to the main helical blade in at least a part of the axial direction, and
height of the sub helical blade is lower that height of the main helical blade.

3. The developing unit according to claim 2,
wherein the height of the sub helical blade ranges from 0.01 to 0.8 of the height of the main helical blade.

4. The developing unit according to claim 2,
wherein the height of the sub helical blade ranges from 0.1 to 0.7 of the height of the main helical blade.

5. The developing unit according to claim 2,
wherein the height of the sub helical blade ranges from 0.2 to 0.5 of the height of the main helical blade.

6. A process cartridge for an electrophotography system image forming apparatus comprising:
the developing unit according to claim 2,
a photosensitive body on a surface of which a latent image is formed; and
a developer container that contains developers including the toner,
wherein the developing roller develops the latent image on the photosensitive body by supplying the toner to the latent image.

7. The process cartridge for an electrophotography system image forming apparatus according to claim 6,
wherein the height of the sub helical blade ranges from 0.01 to 0.8 of the height of the main helical blade.

8. The process cartridge for an electrophotography system image forming apparatus according to claim 6,
wherein the height of the sub helical blade ranges from 0.1 to 0.7 of the height of the main helical blade.

9. The process cartridge for an electrophotography system image forming apparatus according to claim 6,
wherein the height of the sub helical blade ranges from 0.2 to 0.5 of the height of the main helical blade.

10. An electrophotography system image forming apparatus comprising:
the developing unit according to claim 2; and
a driving device,
wherein the driving device rotates and drives the developing roller of the developing unit and the carrying member with the blades.

11. The electrophotography system image forming apparatus according to claim 10,
wherein the height of the sub helical blade ranges from 0.01 to 0.8 of the height of the main helical blade.

12. The electrophotography system image forming apparatus according to claim 10,
wherein the height of the sub helical blade ranges from 0.1 to 0.7 of the height of the main helical blade.

13. The electrophotography system image forming apparatus according to claim 10,
wherein the height of the sub helical blade ranges from 0.2 to 0.5 of the height of the main helical blade.
